(19) United States
(12) Patent Application Publication
(10) Pub. No.: US 2026/0167139 A1
(43) Pub. Date: Jun. 18, 2026

(54) DEPLOYMENT CIRCUIT FOR A PYROTECHNIC DEVICE, RELATED DEPLOYMENT SYSTEM, AND METHOD

(71) Applicant: STMicroelectronics International N.V., Geneva (CH)

(72) Inventors: Vittorio D'Angelo, Nocera Superiore (IT); Leonardo Pedone, Civitanova Marche (IT); Salvatore Cannavacciuolo, Villaricca (IT); Antonio Giordano, Milano (IT); Mauro Jonathan Pellegrini, Bresso (IT)

(21) Appl. No.: 19/417,006

(22) Filed: Dec. 11, 2025

(30) Foreign Application Priority Data
Dec. 16, 2024 (IT) 102024000028599

(51) Int. Cl. B60R 21/01

(52) U.S. Cl. CPC B60R 21/01; B60R 2021/0115; B60R 2021/01197

(57) ABSTRACT

According to an embodiment, a deployment circuit for controlling the deployment of a pyrotechnic device includes a deployment driver circuit configured to energize the pyrotechnic device, diagnostic circuitry configured to perform diagnostic controls, a communication interface couplable to a microcontroller, a fault signal terminal, and a control circuit comprising a hardware Finite-State Machine. The control circuit executes diagnostic routines, each comprising a sequence of diagnostic operations. In each diagnostic operation, the control circuit generates control signals for the diagnostic circuitry, monitors signals from the diagnostic circuitry, determines whether the signals indicate faults, and, upon detecting faults, asserts the fault signal and stores a fault code. The control circuit receives a request from the microcontroller via the communication interface and transmits the stored fault code, enabling autonomous diagnostic operation with minimal microcontroller intervention.

### CROSS-REFERENCE TO RELATED APPLICATION

This application claims the benefit of Italian Patent Application No. 102024000028599, filed on Dec. 12, 2024, which application is hereby incorporated by reference herein in its entirety.

### TECHNICAL FIELD

The present disclosure relates to solutions for deploying an electrically activated pyrotechnic device, such as a squib, a pyro-fuse, or a pyro-actuator.

### BACKGROUND

Electrically activated pyrotechnic devices serve as indispensable components for delivering substantial amounts of energy within extremely brief deployment windows and, for this reason, are widespread in safety applications. Notably, this category includes squibs used for airbag activation, pyro-fuses designed to swiftly disconnect electrical connections, such as the connection of an electric vehicle (EV) battery in the event of a short-to-ground fault, and pyro-actuators.

In the context of safety applications, various solutions have been proposed to monitor the proper connection of the pyrotechnic device to the deployment circuit. State-of-the-art automotive safety systems for squib or pyro-fuse deployment typically incorporate a microcontroller (MCU) and a squib or pyro-fuse driver that performs periodic resistive-load diagnostics. The existing technology typically involves continuous MCU monitoring to detect potential deployment failure mechanisms, such as, for instance, squib or pyro-fuse failures, or short circuits within the squib or pyro-fuse driver, thus necessitating persistent system operation.

Despite leveraging high-efficiency Power Management Integrated Circuits (PMICs), the constant diagnostic activity results in substantial power consumption. Current implementations strategically manage diagnostic interval timings to mitigate stress on critical semiconductor or passive components, particularly power MOSFETs and energy storage capacitors, balancing comprehensive system integrity assessment with component preservation requirements.

At the system architectural level, contemporary mission-critical applications demand sophisticated diagnostic methodologies that ensure real-time, automated, and highly reliable fault detection. Existing technological approaches consistently employ computationally intensive MCU-based polling strategies, which introduce significant drawbacks: elevated power consumption, substantial computational overhead, and accelerated component aging.

Moreover, current diagnostic solutions integrate an integrated circuit (IC) resource with external microcontroller (MCU) capabilities to validate resistive load integrity. The diagnostic workflow systematically manages a process in which the MCU enables IC diagnostic resources, acquires measurement data, computes critical parameters, and compares them against predefined thresholds. This approach inherently consumes MCU processing bandwidth, diverting computational resources from other system tasks and potentially introducing operational inefficiencies.

An exemplary embodiment of solutions of this kind is illustrated in FIG. 1, wherein a deployment system 10 comprises a squib or pyro-fuse deployment circuit 15, a microcontroller unit 11, a power management circuit 12, and a squib or pyro-fuse 30.

As pictured, the squib or pyro-fuse deployment circuit 15 is coupled to the microcontroller 11 and to the squib or pyro-fuse 30. In particular, in the example considered the microcontroller 11 and the deployment circuit 15 are coupled through a Serial Peripheral Interface (SPI), wherein the microcontroller 11 is configured as a SPI master and the deployment circuit 15 is configured as an SPI slave.

In fact, as illustrated, the deployment circuit 15 comprises a first chip-select contact NCS that allows the SPI master device i.e., the microcontroller 11, to select the deployment circuit 15 for exchanging data over the bus, a bus clock contact SCLK that allows the microcontroller 11 to transmit to the deployment circuit 15 a clock signal for syncing the transmission of data over the bus, a serial data input contact SDI used for receiving data from the microcontroller 11, and a serial data output contact SDO used for outputting data to the microcontroller 11.

The squib or pyro-fuse deployment circuit 15 comprises a deployment driver 20, which in turn comprises a high-side switch 20a, and a low-side switch 20b, and is used for coupling the squib or pyro-fuse 30 to a power supply. Specifically, a first terminal of the squib or pyro-fuse 30 is coupled via the high-side driver 20a to a supply voltage VBAT, whereas a second terminal is coupled via the low-side switch 20b to ground. The high-side switch 20a and the low-side switch 20b are typically realized using MOSFETs, BJTs, or IGBTs. Further, the deployment circuit 15 comprises an energy reserve capacitor CER that allows it to operate even in the event of energy loss.

As mentioned, the microcontroller 11 is configured to continuously monitor the resistive load coupled to the deployment circuit 15, i.e., the squib or pyro-fuse 30, to detect potential failure points that may prevent a successful deployment, if necessary. Of course, such monitoring requires that microcontroller 11 remain active, thereby increasing system power consumption, even when supplied by a high-efficiency power management circuit 12.

In view of the above, it is clear that solutions available nowadays based on time-aggressive polling strategies implemented by a microcontroller unit have the drawbacks of high computational effort, increased system power consumption, and accelerated aging of the system's electrical components. This is particularly relevant in the context of battery electric vehicles (BEVs), which require continuous monitoring of the high-voltage batteries they contain, even when parked, to meet safety requirements.

Therefore, the need is felt for a reliable, automatic, and real-time diagnostics to comply with ever more stringent safety requirements.

### SUMMARY

Given the mission-critical nature of numerous applications in which squibs, pyro-fuses, or pyrotechnic devices are employed, a need exists for innovative solutions that can perform required diagnostics while reducing power consumption and preserving the integrity of electrical components.

According to one or more embodiments, such an object may be achieved by means of a deployment circuit for a pyrotechnic device. Embodiments, moreover, concern a related deployment system and method.

The disclosure is defined by the appended independent claims. The claims are an integral part of the technical teaching of the disclosure provided herein.

As mentioned before, various embodiments of the present disclosure relate to a deployment circuit configured to control the deployment of a pyrotechnic device. In various embodiments, the deployment circuit, e.g., integrated in an integrated circuit, comprises a positive power supply terminal and a negative power supply terminal configured to receive a supply voltage, and a first terminal and a second terminal couplable to a pyrotechnic device. A deployment driver circuit is configured to energize the pyrotechnic device by coupling the first and second terminals to the supply voltage.

In various embodiments, the deployment circuit comprises a diagnostic circuitry configured to perform diagnostic controls on the deployment circuit, a communication interface couplable to a microcontroller, and a terminal couplable to the microcontroller to provide a fault signal to the microcontroller. The communication interface may be a serial communication interface, such as a Serial Peripheral Interface (SPI).

In various embodiments, the deployment circuit comprises a control circuit comprising a hardware Finite-State Machine, such as a sequential logic circuit, configured to execute one or more diagnostic routines, wherein each diagnostic routine comprises a sequence of diagnostic operations. Specifically, in each diagnostic operation, the control circuit is configured to generate one or more control signals for the diagnostic circuitry to execute a diagnostic operation of the deployment circuit, monitor one or more signals provided by the diagnostic circuitry and determine whether the one or more signals indicate one or more faults of the deployment circuit. Upon determining that one or more signals indicate one or more faults in the deployment circuit, the control circuit asserts the fault signal and stores a fault code indicative of the detected fault. Accordingly, upon determining that the fault signal is asserted, the microcontroller may send a request to the deployment circuit to receive the stored fault code; i.e., the control circuit is configured to receive via the communication interface a request and, in response to the request, transmit the stored fault code.

In various embodiments, the control circuit comprises a memory for storing first data indicating a repetition period for the execution of at least one of the diagnostic routines, or for each diagnostic operation, second data indicating after how many cycles of a given diagnostic routine the respective diagnostic operation should be executed. Accordingly, the control circuit may be configured to execute one or more diagnostic routines and the corresponding diagnostic operation as a function of the first and second data.

In various embodiments, the first data or the second data are programmable via the communication interface. For example, the microcontroller may send a request to the deployment circuit to program either the first or the second data. Next, the microcontroller may enable the low-power state and, in response to determining that the fault signal is asserted, enable the normal operating state and send the request to receive the stored fault code.

Accordingly, the control circuit and diagnostic circuit may execute various diagnostic operations. In the following, embodiments of possible diagnostic operations will be described. In this respect, the terms “first,” “second,” “third,” etc. are used to distinguish the diagnostic operations and phases, and the terms do not imply a time order or that a higher order operation, e.g., “second,” implies that also the lower order operations, e.g., “first,” have to be executed. Thus, in general, the various operations and phases may be used in any suitable order and combination.

For example, in various embodiments, the diagnostic circuitry comprises a voltage regulator and a current monitor circuit. In various embodiments, the voltage regulator and current monitor circuit comprises a voltage source comprising an output terminal for providing a reference voltage, a switching circuit configured to couple the output terminal of the voltage source to the first terminal and the second terminal as a function of a switching circuit control signal received from the control circuit, and a current monitor configured to provide a signal indicative of the current flowing through the output terminal of the voltage source, wherein the signal is provided to the control circuit.

In this case, a first diagnostic operation may comprise a respective first phase, wherein the control circuit is configured to generate the switching circuit control signal to couple the output terminal of the voltage source to the first terminal, monitor the signal indicative of the current flowing through the output terminal of the voltage source and determine whether the signal indicates a current flow between the first terminal and the output terminal of the voltage source. Upon determining that the signal indicates current flow between the first terminal and the output terminal of the voltage source, the control circuit may assert the fault signal and store a fault code indicative of the leakage condition at the first terminal.

Additionally or alternatively, the first diagnostic operation may comprise a respective second phase, wherein the control circuit is configured to generate the switching circuit control signal to couple the output terminal of the voltage source to the second terminal, monitor the signal indicative of the current flowing through the output terminal of the voltage source and determine whether the signal indicates a current flow between the second terminal and the output terminal of the voltage source. Upon determining that the signal indicates current flow between the second terminal and the output terminal of the voltage source, the control circuit may assert the fault signal and store a fault code indicative of the leakage condition at the second terminal.

In various embodiments, the deployment driver circuit comprises a high-side electronic switch coupled between the positive power supply terminal and the first terminal, wherein the high-side electronic switch is closed as a function of a high-side switch control signal received from the control circuit, and a low-side electronic switch coupled between the second terminal and the negative power supply terminal, wherein the low-side electronic switch is closed as a function of a low-side switch control signal received from the control circuit.

In this case, a second diagnostic operation may comprise a respective first phase, wherein the control circuit is configured to generate the switching circuit control signal to couple the output terminal of the voltage source to the first terminal, generate the high-side switch control signal to close the high-side electronic switch, monitor the signal indicative of the current flowing through the output terminal of the voltage source and determine whether the signal indicates a current flow from the first terminal to the output terminal of the voltage source. Upon determining that the signal does not indicate current flow from the first terminal to the output terminal of the voltage source, the control circuit may assert the fault signal and store a fault code indicative of failure of the high-side electronic switch.

Additionally or alternatively, the second diagnostic operation may comprise a respective second phase, wherein the control circuit is configured to generate the switching circuit control signal to couple the output terminal of the voltage source to the second terminal, generate the low-side switch control signal to close the low-side electronic switch, monitor the signal indicative of the current flowing through the output terminal of the voltage source and determine whether the signal indicates a current flow from the output terminal of the voltage source to the second terminal. Upon determining that the signal does not indicate current flow from the output terminal of the voltage source to the second terminal, the control circuit may assert the fault signal and store a fault code indicative of failure of the low-side electronic switch.

In various embodiments, the diagnostic circuitry comprises a first current limiter coupled between the positive power supply terminal and the first terminal, wherein the first current limiter is enabled as a function of a first enable signal received from the control circuit, and a second current limiter coupled between the second terminal and the negative power supply terminal, wherein the second current limiter is enabled as a function of a second enable signal received from the control circuit.

In this case, when also comprising the voltage regulator and current monitor circuit, a third diagnostic operation may comprise a respective first phase, wherein the control circuit is configured to generate the switching circuit control signal to couple the output terminal of the voltage source to the first terminal, generate the first enable signal to enabled the first current limiter, monitor the signal indicative of the current flowing through the output terminal of the voltage source and determine whether the signal indicates a current flow from the first terminal to the output terminal of the voltage source. In response to determining that the signal does not indicate a current flow from the first terminal to the output terminal of the voltage source, the control circuit may assert the fault signal and store a fault code indicative of failure in the operation of the voltage regulator, the current monitor circuit, and the first current limiter.

Additionally or alternatively, the third diagnostic operation may comprise a respective second phase, wherein the control circuit is configured to generate the switching circuit control signal to couple the output terminal of the voltage source to the second terminal, generate the second enable signal to enabled the second current limiter, monitor the signal indicative of the current flowing through the output terminal of the voltage source and determine whether the signal indicates a current flow from the output terminal of the voltage source to the second terminal. Upon determining that the signal does not indicate a current flow from the output terminal of the voltage source to the second terminal, the control circuit may assert the fault signal and store a fault code indicative of failure in the operation of the voltage regulator, the current monitor circuit, and the second current limiter.

In various embodiments, the deployment circuit comprises an analog-to-digital converter comprising an input, wherein the analog-to-digital converter is configured to provide a signal indicative of the voltage at the input of the analog-to-digital converter, and a further switching circuit configured to couple the input of the analog-to-digital converter to the first terminal and the second terminal as a function of a further switching circuit control signal.

In this case, the diagnostic circuitry may comprise a first voltage source configured to provide a first voltage and a second voltage source configured to provide a second voltage, wherein the further switching circuit is configured to couple the input of the analog-to-digital converter to the first voltage source or the second voltage source as a function of the further switching circuit control signal. In this case, a fourth diagnostic operation may comprise a respective first phase, wherein the control circuit is configured to generate the further switching circuit control signal to decouple the input of the analog-to-digital converter form the first terminal and the second terminal, and couple the input of the analog-to-digital converter to the first voltage source, monitor the signal indicative of the voltage at the input of the analog-to-digital converter and determine whether the signal has a first expected value. Upon determining that the signal does not have the first expected value, the control circuit may assert the fault signal and store a fault code indicative of an analog-to-digital converter error.

Additionally or alternatively, the fourth diagnostic operation may comprise a respective second phase, wherein the control circuit is configured to generate the further switching circuit control signal to decouple the input of the analog-to-digital converter form the first terminal and the second terminal, and couple the input of the analog-to-digital converter to the second voltage source, monitor the signal indicative of the voltage at the input of the analog-to-digital converter and determine whether the signal has a second expected value. In response to determining that the signal does not have the second expected value, the control circuit may assert the fault signal and store a fault code indicative of an analog-to-digital converter error.

In various embodiments, in a fifth diagnostic operation, the control circuit is configured to generate the further switching circuit control signal to couple the input of the analog-to-digital converter to the first terminal and the second terminal, generate the first enable signal to enabled the first current limiter and generate the second enable signal to enabled the second current limiter, monitor the signal indicative of the voltage at the input of the analog-to-digital converter, determine a value indicative of the resistance between the first terminal and the second terminal as a function of the signal indicative of the voltage at the input of the analog-to-digital converter and determine whether the value indicative of the resistance between the first terminal and second terminal is between a first threshold and a second threshold. In response to determining that the value indicative of the resistance between the first terminal and the second terminal is not between a first threshold and a second threshold, the control circuit may assert the fault signal and store a fault code indicative of an error of the pyrotechnic device.

### BRIEF DESCRIPTION OF THE DRAWINGS

Embodiments of the present disclosure will now be described with reference to the annexed drawings, which are provided purely by way of non-limiting example and in which:

FIG. 1 shows a deployment system for a pyrotechnic device;

FIG. 2 shows an embodiment of a deployment system for a pyrotechnic device;

FIG. 3 shows a method for performing diagnostic controls in the deployment system of FIG. 2;

FIG. 4 shows a circuit for testing an analog-to-digital converter of the deployment system of FIG. 2;

FIGS. 5A and 5B show a circuit for testing a voltage regulator and current monitoring circuit of the deployment system of FIG. 2;

FIGS. 6A, 6B, 6C, and 6D show a circuit configured to determine a possible leakage condition at the terminals of the pyrotechnic device by using the voltage regulator and current monitoring circuit of FIGS. 5A and 5B;

FIG. 7 shows a circuit for verifying the correct coupling of a pyrotechnic device to the deployment system of FIG. 2;

FIGS. 8A, 8B, 8C, and 8D show a circuit for testing the switches of a driver circuit of the deployment system of FIG. 2;

FIG. 9 shows a circuit for testing energy reserve capacitors of the deployment system of FIG. 2; and

FIGS. 10A, 10B, and 10C show further embodiments of methods for performing diagnostics in the deployment system of FIG. 2.

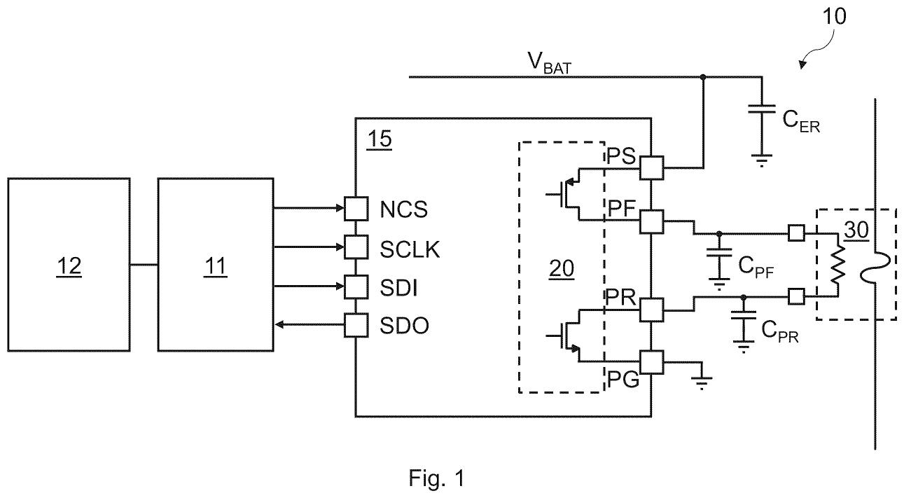

### DETAILED DESCRIPTION OF ILLUSTRATIVE EMBODIMENTS

This disclosure provides many applicable inventive concepts that can be embodied in a wide variety of specific contexts. The particular embodiments are merely illustrative of specific configurations and do not limit the scope of the claimed embodiments. Features from different embodiments may be combined to form further embodiments unless noted otherwise. Various embodiments are illustrated in the accompanying drawing figures, where identical components and elements are identified by the same reference number, and repetitive descriptions are omitted for brevity.

Variations or modifications described in one of the embodiments may also apply to others. Further, various changes, substitutions, and alterations can be made herein without departing from the spirit and scope of this disclosure as defined by the appended claims.

The following description provides numerous specific details to provide a thorough understanding of the embodiments. The embodiments can be practiced without one or several specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The headings provided herein are for convenience only and do not interpret the scope or meaning of the embodiments.

As mentioned before, various embodiments of the present disclosure provide solutions for performing diagnostics in a deployment system for managing the deployment of a pyrotechnic device, such as a squib or a pyro-fuse.

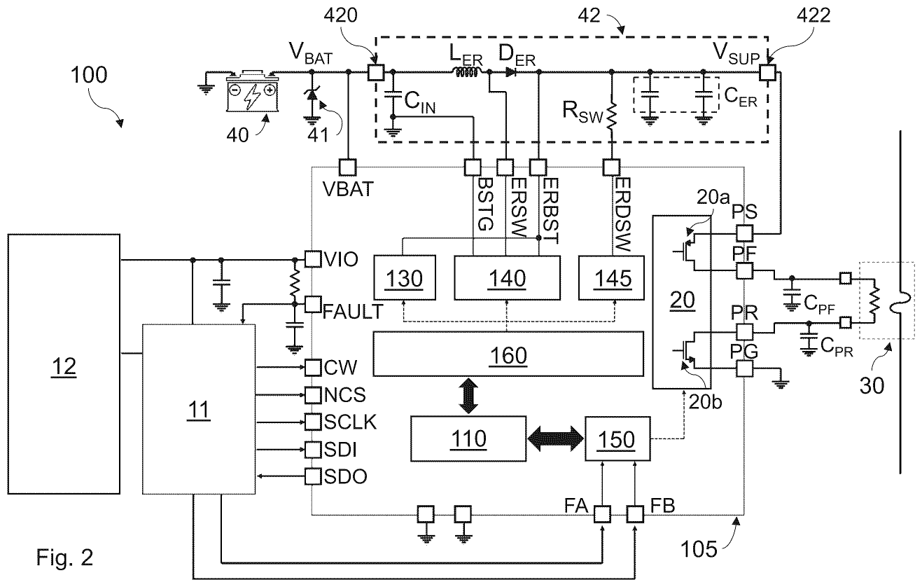

FIG. 2 illustrates an embodiment of a deployment system 100 according to the present disclosure. In the embodiment considered, the deployment system 100 comprises a deployment circuit 105, e.g., integrated in a respective integrated circuit, a microcontroller unit 11, a power management circuit 12, a pyrotechnic device 30, and a battery 40. The deployment circuit 105 is coupled to the microcontroller 11, the power management circuit 12, the squib or pyro-fuse 30, and the battery 40.

In various embodiments, the power management circuit 12 is configured to provide, as an output, one or more stable voltages used to supply electrical energy to the deployment system 100. For instance, in the embodiment considered, the power management circuit 12 supplies a stable voltage, e.g., 3.3 V or 5 V, to the deployment circuit 105, which is received at the power supply terminal VIO of the deployment circuit 105.

In various embodiments, the deployment circuit 105 is coupled to the microcontroller 11 through a communication system, preferably a serial communication system, i.e., the deployment circuit 105 comprises a communication interface, preferably a serial communication interface, such as a Serial Peripheral Interface (SPI), an Inter Integrated Circuit (I2C), a Universal Synchronous-Asynchronous Receiver/Transmitter (UART), a Controller Area Network (CAN) or an Ethernet interface. For example, in various embodiments, the deployment circuit 105 is coupled to the microcontroller 11 through an SPI bus, wherein the deployment circuit 105 is configured as an SPI slave, and the microcontroller 11 is configured as an SPI master device. In this regard, the deployment circuit 105 comprises a clock terminal SCLK, a serial data input terminal SDI, and a serial data output terminal SDO. The clock terminal SCLK is used for transmitting a clock signal used for synchronizing data transmission between the master and slave devices. The clock signal is generated by the master device, i.e., the microcontroller 11, which coordinates when data is sent and received; data is typically transmitted on the rising or falling edges of the clock signal, ensuring that both the master and slave devices are in sync during communication. The SDI (Serial Data In) terminal is used in the deployment circuit 105 to receive data from the master device, i.e., the microcontroller 11, which can send data to the slave device, i.e., the deployment circuit 105, via the SDI line. For instance, the deployment circuit 105 may receive commands or data from the microcontroller 11. In a complementary manner, the SDO (Serial Data Out) terminal is used in the deployment circuit 105 for sending data or instructions to the microcontroller 11.

In various embodiments, e.g., for an SPI interface, the deployment circuit 105 also comprises a chip-select terminal NCS. The chip-select terminal NCS allows a master device, e.g., the microcontroller 11, to select and communicate with a specific slave device, such as the deployment circuit 105 or the power management circuit 12.

In various embodiments, the deployment circuit 105 also comprises a wake-up terminal CW. Specifically, the wake-up terminal CW is used to transmit wake-up signals between the microcontroller 11 and the deployment circuit 105. For example, microcontroller 11 may periodically send a wake-up signal to deployment circuit 105 to manage power states.

In various embodiments, the deployment circuit 105 is configured to produce as output an asserted fault signal indicative of the detection of an anomaly in the deployment circuit 105. The fault signal is outputted at a FAULT terminal comprised in the deployment circuit 105, and may be a one-bit signal, allowing interrupt-based diagnostic strategies fostering the microcontroller 11 resources, i.e., the fault signal may be used to generate an interrupt within the microcontroller 11, e.g., to wake-up the microcontroller 11 from a standby condition.

In the embodiment considered, the deployment circuit 105 comprises a control unit/circuit 110 and a deployment driver circuit 20. Specifically, in various embodiments, the deployment driver circuit 20 is configured to energize the pyrotechnic device 30, e.g., the squib or pyro-fuse. For example, in the embodiment considered, the deployment circuit 105 comprises a (positive) power supply terminal PS and a (negative) power supply terminal PG configured to receive a supply voltage VSUP. Moreover, the deployment circuit 105 comprises a first terminal PF and a second terminal PR couplable to the pyrotechnic device 30. For example, in various embodiments, the deployment driver 20 comprises a high-side electronic switch 20a, and a low-side electronic switch 20b, i.e., the electronic switch 20a is coupled between the terminals PS and PF, and the electronic switch 20b is coupled between the terminals PR and PG. The high-side switch 20a and the low-side switch 20b may be realized using a MOSFET, a BJT, or an IGBT. In various embodiments, one or more current limiters may be coupled in series with the electronic switches 20a or 20b. For example, a first current limiter may be coupled with the electronic switch 20a between the terminals PS and PF, or a second current limiter may be coupled with the electronic switch 20b between the terminals PR and PG.

In various embodiments, the supply voltage VSUP may be provided by a battery 40, i.e., the voltage VSUP may correspond to the voltage VBAT at the battery 40. Conversely, in various embodiments, the deployment system 100 comprises one or more electronic converters for generating the supply voltage VSUP based on the battery voltage VBAT. For example, the electronic converter may be a boost converter, e.g., in case of a low-voltage battery 40 typically provided in an internal combustion engine vehicle, or a buck converter, e.g., in case of a high-voltage battery typically provided in battery electric vehicles.

For example, FIG. 2 shows an embodiment wherein the electronic converter comprises a switching circuit 42 and an electronic converter control circuit 140. In various embodiments, the electronic converter control circuit 140 is implemented within the deployment circuit 105.

For example, in the embodiment considered, the switching circuit 42 is a boost converter comprising an input terminal 420 couplable to the battery voltage VBAT and an output terminal 422 configured to provide the supply voltage VSUP. Moreover, the switching circuit 42 comprises an inductance LER and a diode DER coupled in series between the terminals 420 and 422, and one or more (output or energy reserve) capacitances CER coupled between the output terminal 422 and ground. In various embodiments, the switching circuit 42 also comprises one or more (input) capacitances CIN coupled between the output terminal 420 and ground. In various embodiments, a transient voltage suppression diode 41 may be coupled between the terminal 420 and ground, e.g., to clamp over-voltages and dissipate high transient power surges.

Specifically, in the embodiment considered, the electronic converter control circuit 140 is configured to selectively couple the intermediate node between the inductance LER and diode DER to ground. For example, in the embodiment considered, the deployment circuit 105 comprises a terminal ERSW couplable to the intermediate node between the inductance LER and diode DER, and a terminal BSTG couplable to ground. Accordingly, in the embodiment considered, the electronic converter control circuit 140 is configured to selectively couple the terminal ERSW to ground, e.g., via an electronic switch coupled between the terminal ERSW and BSTG. In various embodiments, the switch may be internal or external with respect to the deployment circuit 105.

In fact, as usual in a boost converter, when the intermediate node between the inductance LER and the diode DER is coupled to ground during a switch-on period TON, the current flowing through the inductance LER increases substantially linearly. Conversely, when the intermediate node between the inductance LER and the diode DER is not coupled to ground during a switch-on period TON, the current flowing through the inductance LER passes to the output terminal 422, thereby charging the capacitance(es) CER.

In the embodiment considered, the deployment circuit 105 also comprises a terminal ERBST couplable to the terminal 422, i.e., the voltage VSUP. For example, the terminal ERBST may be used to provide feedback on the voltage VSUP, and the electronic converter control circuit 140 may be configured to vary the times TON and TOFF to regulate the voltage VSUP to a requested value.

In various embodiments, the deployment circuit 105 may comprise an internal voltage regulator 130 configured to generate one or more internal supply voltages, e.g., for controlling the operation of the driver circuit 20. In various embodiments, the internal voltage regulator 130 may be supplied by the battery voltage VBAT or the supply voltage VSUP. For example, in various embodiments, the internal voltage regulator 130 receives the voltage at the terminal ERBST, i.e., the supply voltage VSUP. In fact, in this way, the deployment circuit 105 remains operative even in the event of a power failure of the battery voltage VBAT, because the capacitance(es) CER act as an energy reserve for the supply voltage VSUP.

As shown in FIG. 2, in various embodiments, the deployment circuit 105 may also comprise a terminal VBAT couplable to the battery 40, e.g., the terminal 420. For example, the deployment circuit 105 may monitor the battery voltage VBAT to detect a battery failure.

In various embodiments, the deployment circuit 105 also comprises a discharge circuit 145 configured to selectively discharge the capacitance(s) CER. For example, in the embodiment considered, the deployment circuit 105 comprises a terminal ERDSW couplable, e.g., via a resistance RDCH, to the terminal 422. For example, in various embodiments, the discharge circuit 145 is configured to selectively couple the terminal ERDSW to ground, e.g., to the terminal BSTG. For example, the discharge circuit 145 may comprise, for this purpose, an electronic switch. In various embodiments, the switch may be internal or external with respect to the deployment circuit 105.

In various embodiments, the deployment circuit 105 comprises a first arming terminal FA and a second arming terminal FB, couplable to the microcontroller 11, and an arming logic circuit 150 that receives signals from the arming terminals FA and FB. For instance, the microcontroller 11 may send instructions to the deployment circuit 105 to arm the deployment driver 20 in response to specific events. Accordingly, in various embodiments, the arming logic circuit 150 is configured to arm the driver circuit 20, thereby preparing the squib or pyro-fuse 30 for activation or deployment. Such an arming procedure ensures that the pyrotechnic device 30 is ready to be triggered when needed, typically by an external signal or condition, such as the deployment of an airbag. In particular, the microcontroller 11 may send arming signals to the arming logic circuit 150 to prepare the pyrotechnic device 30 for deployment, for instance, upon detecting an incident.

In various embodiments, the deployment circuit 105 may comprise further circuits, such as one or more digital comparators, or one or more analog-to-digital converters, ADCs. Such components are not represented in FIG. 2 for the sake of simplicity, as they may be useful for acquiring voltages and other electrical quantities. For example, measuring the battery voltage VBAT may involve an analog-to-digital converter. In general, the analog comparators and the ADCs may be provided in one or more circuits of the deployment circuit 105 such as, for instance, the control unit 110 or the deployment driver circuit 20.

In various embodiments, the control unit 110 is configured to periodically run diagnostic routines to detect anomalies in the deployment system 100. For this purpose, in various embodiments, the deployment circuit 105 comprises a diagnostic circuit 160. For example, the diagnostic circuit 160 may be configured to monitor one or more circuits of the deployment circuit 105, such as the voltage regulator 130, the electronic converter control circuit 140, the discharge circuit 145, or the driver circuit 20. An exemplary diagnostic routine comprises one or more of the following controls: an analog comparator test, an analog-to-digital converter test, a voltage regulator/current monitor test, an output leakage test, a connection test of the pyrotechnic device, a deployment switch test, and an energy reserve capacitor test.

In particular, in various embodiments, the control unit 110 is configured to repeat the diagnostic controls at a common test rate ZT. Alternatively, in various embodiments, each diagnostic check is associated with a respective testing rate, providing users with greater flexibility in arranging a desired diagnostic routine. For example, a user may need to perform diagnostic checks that are simpler, less power-consuming, and less stressful on components more often, whereas checks that are more power-consuming or that cause more stress on the electrical components are performed at a lower repetition rate.

In various embodiments, the diagnostic circuitry 160 is configured to perform, in cooperation with the control unit 110, one or more of the aforementioned diagnostic checks.

FIG. 3 illustrates a method 300 for diagnosing the deployment system 100. For example, the operation shown in FIG. 3 may be implemented via the control circuit 110, which generates control signals for the diagnostic circuit(s) 160 to perform respective tests.

In the embodiment considered, after a starting step, performed for instance when the deployment system 100 is powered on e.g., at the turn-on of a vehicle comprising the deployment system 100, the control unit 110 performs in a step 301 a diagnostic check on one or more analog comparators of the deployment circuit 105.

For example, during step 301, the control unit 110 assesses whether the analog comparators included in the deployment system 100 are working correctly in accordance with practices known to the person skilled in the art. To this end, the testing circuitry 160 may include additional circuitry to perform such a diagnostic check. Upon detecting a fault in the analog comparators, the control unit 110 asserts the FAULT signal to notify the microcontroller 11 of a fault in the deployment circuit 105. In addition to asserting the fault signal FAULT, the control unit 110 outputs a respective fault code ZF at the SDO terminal to indicate that one or more analog comparators exhibit anomalous behavior during the test. For example, in the context of an SPI protocol, the control circuit 110 may assert the FAULT signal. In response to determining that the fault signal FAULT is asserted, the microcontroller 11 sends via the (e.g., SPI) interface a request/command and the control circuit 110 returns the fault code ZF.

Successively, at step 302, the control unit 110 performs a diagnostic check on one or more analog-to-digital converters of the deployment circuit 105, in particular to assess the integrity of the ADC's conversion paths.

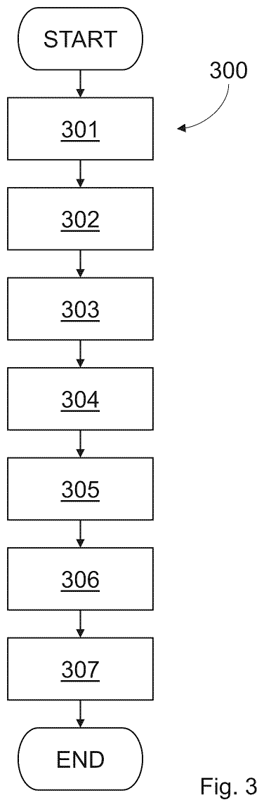

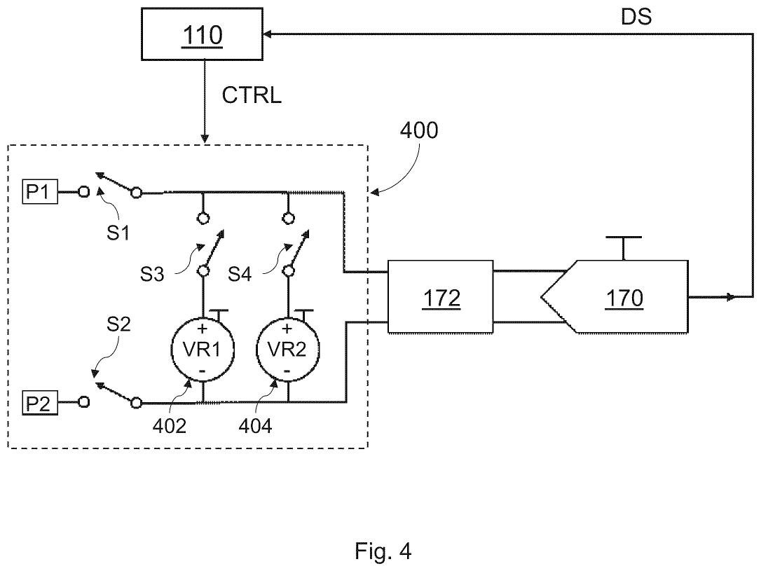

In this regard, FIG. 4 shows an embodiment of an ADC testing circuit 400 for an analog-to-digital converter (ADC) 170. For example, the ADC 170 may be integrated in the control circuit 110.

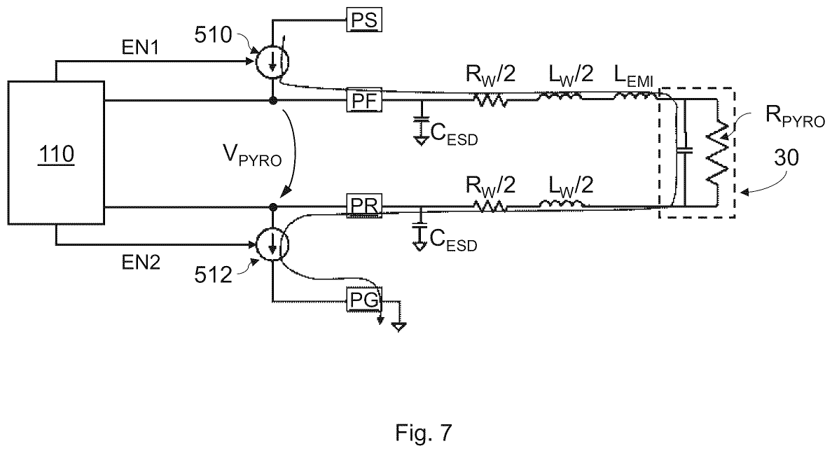

For example, the ADC testing circuit 400 may be integrated in the diagnostic circuit 160 shown in FIG. 2. In the embodiment considered, the ADC 170 is coupled to terminals P1 and P2. For example, as will be described with respect to FIG. 7, the terminals P1 and P2 may correspond to the terminals PF and PR shown in FIG. 2. However, the terminals P1 and P2 may also be coupled to other voltages. For example, the terminal P2 may be coupled to ground (e.g., the terminal BSTG) and the terminal P1 may be coupled to the terminal VBAT or ERBST. In various embodiments, the control circuit 110 may control the coupling of the terminals P1 and P2 via a switching circuit, such as a crossbar or multiplexer.

As illustrated, the ADC testing circuit 400 comprises an electronic switch S1 for coupling/decoupling the first contact P1 and a second electronic switch S2 for coupling/decoupling the second contact P2. For example, these electronic switches, P1 and P2, may form part of a crossbar or multiplexer.

In the embodiment considered, the ADC testing circuit 400 comprises a voltage source 402 configured to provide a voltage VR1, and optionally one or more further voltage sources 404 configured to provide respective further voltages, e.g., a voltage VR2. Moreover, the ADC testing circuit 400 comprises an electronic switch S3 for coupling/decoupling the voltage source 402, and, optionally, further electronic switches S4 for coupling/decoupling the additional voltage sources 402. In various embodiments, the control circuit 110 controls the switching state of the electronic switches S1 to S4 via one or more control signals CTRL.

Accordingly, in various embodiments, during the execution of phase 302, the control unit 110, in cooperation with the ADC testing circuit 400, decouples the ADC 170 from the respective inputs P1 and P2 by commanding the switches S1 and S2. Next, the control unit 110 applies different internal reference voltages to the ADC 410 by selectively closing one of the switches S3 and S4. Subsequently, the control unit 110 checks, for each applied testing voltage, the obtained results, indicated in FIG. 4 as the digital sample DS, for conversion errors, e.g., by comparing the digital sample DS with respective threshold values.

In various embodiments, the ADC 170 may have associated a divider or level shifter circuit 172. In this case, the control circuit 110 may also select different divider factors, each time verifying whether the digital sample DS has an expected value.

Upon detecting a fault, the control unit 110 asserts the FAULT signal to notify the microcontroller 11 of a fault in the deployment circuit 105, and outputs a corresponding fault code ZF on the serial data output terminal SDO to signal the detected error.

In other words, the analog-to-digital converter testing circuit 400 is configured to selectively couple the voltage source 402 or one of the optional further voltage sources 404 to the analog-to-digital converter 170 under test by means of a plurality of switches S1, S2, S3, S4, to subsequently compare one or more values DS outputted by the analog-to digital converter 170 under test to respective expected/reference values and, in response to detecting that at least one outputted value is different from the respective expected/reference value, signal a fault in the analog-to-digital converter under test by asserting the fault signal FAULT and by outputting a respective fault code ZF.

In various embodiments, the circuit 400 (or an additional circuit) may be used to test an analog comparator. For example, in this way, the switches S1 and S2 may be used to decouple the analog comparator from respective terminals P1 and P2. The switches S3 and S4 may be used to couple the comparator sequentially to two voltages VR1 and VR2, wherein one voltage is above the threshold value of the analog comparator and the other voltage is below the threshold value of the analog comparator, wherein the control circuit 110 monitors in both cases the logic level of the comparison signal provided by the analog comparator.

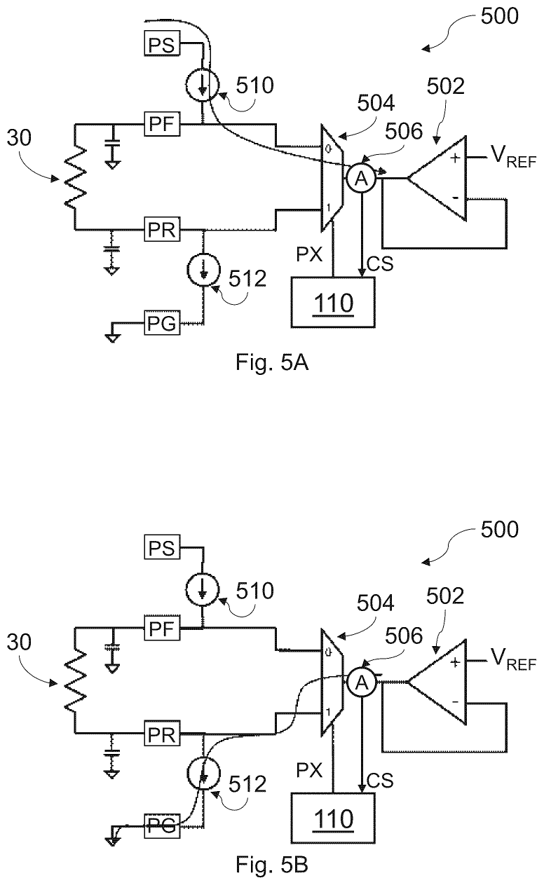

In step 303, the control unit 110 performs a diagnostic of the voltage regulator and current monitor circuit 500. Specifically, as shown in FIGS. 5A and 5B, in various embodiments, the diagnostic circuit 160 comprises a voltage regulator/current monitor circuit 500. Specifically, the circuit 500 is configured to apply a voltage VREF to the terminal PF or PR and to monitor a signal indicative of the current flowing through the circuit 500's output. For example, in the embodiment considered, the circuit 500 comprises a voltage source 502. For example, in the embodiment considered, the voltage source 502 is implemented with a voltage follower receiving a reference voltage VREF. However, other voltage sources may also be used. In various embodiments, the voltage VREF provided by the voltage source 500 is smaller than the voltage VSUP, e.g., VREF is approximately 50% of VSUP. For example, for this purpose, the voltage VREF may be provided by a voltage divider coupled between the voltage VSUP. However, the voltage source 502 may also provide different voltages. For example, in various embodiments, the voltage VREF is selected within a range of 2 to 5 V, e.g., 2.5 V. For example, the voltage VREF may be provided by the voltage regulator 130. In various embodiments, the voltage source 502 may correspond to the voltage source 402 shown in FIG. 4, whereby the voltage VREF corresponds to the voltage VR1 and has already been tested during the step 302.

In various embodiments, the voltage source 502 also comprises a current limiter (not shown in the Figures), configured to limit the amplitude of the current at the output of the voltage source 502 to a maximum value, i.e., the current sunk or sourced by the voltage source 502 is limited.

Moreover, in the embodiment considered, the circuit 500 comprises a switching circuit 504 configured to selectively couple the output of the voltage source 502 to the terminal PF or PR as a function of a control signal PX. For example, in FIGS. 5A and 5B, a multiplexer 504 is shown; however, the output of the voltage source 502 may be coupled via a first electronic switch to the terminal PF and via a second electronic switch to the terminal PR.

Moreover, in various embodiments, the circuit 500 comprises a current sensor 506 configured to generate a signal CS indicative of (and preferably proportional to) the current provided or sunk by the voltage source 502. For example, in the embodiment considered, the current sensor 506 is arranged between the output of the voltage source 502 and the switching circuit 504.

Accordingly, the control circuit 110 may generate the signal PX to couple the voltage source 502 to the terminal PF or PR (or decouple the voltage source 502) and monitor the signal CS. For example, to monitor the signal CS, the control circuit 110 may comprise one or more analog comparators or may receive a digital sample of the signal CS via an ADC 170. For example, in various embodiments, the control circuit 110 or directly the circuit 500 comprises also one or more analog current comparators configured to generate one or more signals indicating whether the current sunk by the voltage source 502 (i.e., a negative current flow at the output of the voltage source 502) exceeds a first threshold or whether the current sourced by the voltage source 502 (i.e., a positive current flow at the output of the voltage source 502) exceeds a second threshold. In various embodiments, the thresholds are selected to detect current flows that are smaller than the maximum current limiter value of the voltage source 502. For example, in various embodiments, the control circuit 110 is configured to use one or more signals to determine whether the current at the output of the voltage source 502 is substantially zero. In various embodiments, the control circuit 110 is configured to determine the direction of current flow using one or more signals. As described in greater detail below, the circuit 500 is used to perform various tests, such as a leakage test.

Moreover, in various embodiments, as will be described with respect to FIG. 7, to test the connection of a pyrotechnic device 30, the control circuit 110 is configured to monitor a value RM indicative of the resistance RPYRO between the terminals PF and PR. For this purpose, the control circuit 110 may enable a (small) current flow IMEAS through the terminal PF and PR.

Specifically, in various embodiments, the diagnostic circuit 160 comprises, for this purpose, a first current source or limiter 510 coupled between the terminals PS and PF, and a second current source or limiter 512 coupled between the terminals PR and PG. Specifically, the current limiter 510 is configured to limit the current flowing between the terminal PS and PF to the measurement current IMEAS, and the current limiter 512 is configured to limit the current flowing between the terminal PR and PG to the same measurement current IMEAS. Specifically, while FIGS. 5A and 5B show the current limiters 510 and 512, indeed, these current limiters may be selectively enabled via respective control signals provided by the control circuit 110. For example, the current limiters 510 and 512 may each comprise an electronic switch for coupling the current limiter between its respective terminals. For example, in FIG. 7, the control circuit 110 is configured to generate a signal EN1 to enable the current limiter 510 and a signal EN2 to enable the current limiter 512.

Specifically, in various embodiments, the control unit 110 performs at step 303 a diagnostic of the voltage regulator and current monitor circuit 500. In various embodiments, the diagnostics of the voltage regulator and current monitor module 500 comprises performing two steps.

Specifically, in the first phase shown in FIG. 5A, the control circuit 110 enables the current limiter 510 (e.g., by asserting the enable signal EN1 and de-asserting the enable signal EN2) and drives the switching circuit 504 (via the signal PX) to couple the voltage source 502 to the terminal PF. Accordingly, when the current limiter 510, the switching circuit 504, the current sensor 506 and the voltage source 502 are working correctly, a current will flow from the terminal PS to the voltage reference VREF. Accordingly, by comparing the signal CS with an expected value, the control circuit 110 may determine whether the voltage regulator and current monitor circuit 500 and the current limiter 510 are working correctly. Alternatively, the control circuit 110 may determine, e.g., via an analog comparator, the direction of the current flow, i.e., whether a current is flowing from the terminal PF to the output of the voltage source 502, e.g., because the signal CS indicates a negative current flow.

Accordingly, in various embodiments, in response to detecting that the signal CS does not have the expected value, the control circuit asserts the fault signal FAULT while outputting a respective error code ZF at the output terminal SDO. After the first step is performed, the first current generator 510 is switched off.

Conversely, in the second phase shown in FIG. 5B, the control circuit 110 enables the current limiter 512 (e.g., by asserting the enable signal EN2 and de-asserting the enable signal EN1). It drives the switching circuit 504 (via the signal PX) to couple the voltage source 502 to the terminal PR. Accordingly, when the current limiter 510, the switching circuit 504, the current sensor 506, and the voltage source 502 are working correctly, a current will flow from the voltage reference VREF to the terminal PG. Accordingly, by comparing the signal CS with an expected value, the control circuit 110 may determine whether the voltage regulator and current monitor circuit 500 and the current limiter 512 are working correctly. Alternatively, the control circuit 110 may just determine, e.g., via an analog comparator, the direction of the current flow, i.e., whether a current is flowing from the output of the voltage source 502 to the terminal PR, e.g., because the signal CS indicates a positive current flow.

Accordingly, in various embodiments, upon detecting that the signal CS does not have the expected value, the control circuit asserts the fault signal FAULT while outputting a corresponding error code ZF at the output terminal SDO. After the second step is performed, the second current generator 512 is switched off.

In various embodiments, the steps shown in FIGS. 5A and 5B may be inverted. Moreover, in various embodiments, the circuit 500 may be implemented with two voltage sources, wherein the first voltage source is coupled to the terminal PF and the second voltage source is coupled to the terminal PR.

In step 304, the control unit 110 performs a leakage test on the output terminals PF and PR of the deployment circuit 105. In particular, during step 304, the control unit 110 assesses whether the terminals PF and PR exhibit parasitic leakage to the battery or ground.

In various embodiments, this diagnostic check is performed by means of the voltage regulator and current monitor circuit 500, and comprises performing a first step, wherein the high-side switch output PF is tested, and a second test, wherein the low-side switch input PR is tested. Specifically, during these tests, the control circuit 110 is configured to disable the current limiters 510 and 512 shown in FIGS. 5A and 5B, e.g., by de-asserting the enable signal EN1 and EN2, couple the voltage source 502 via the signal PX either to the terminal PF or PR, and monitor the measurement signal CS.

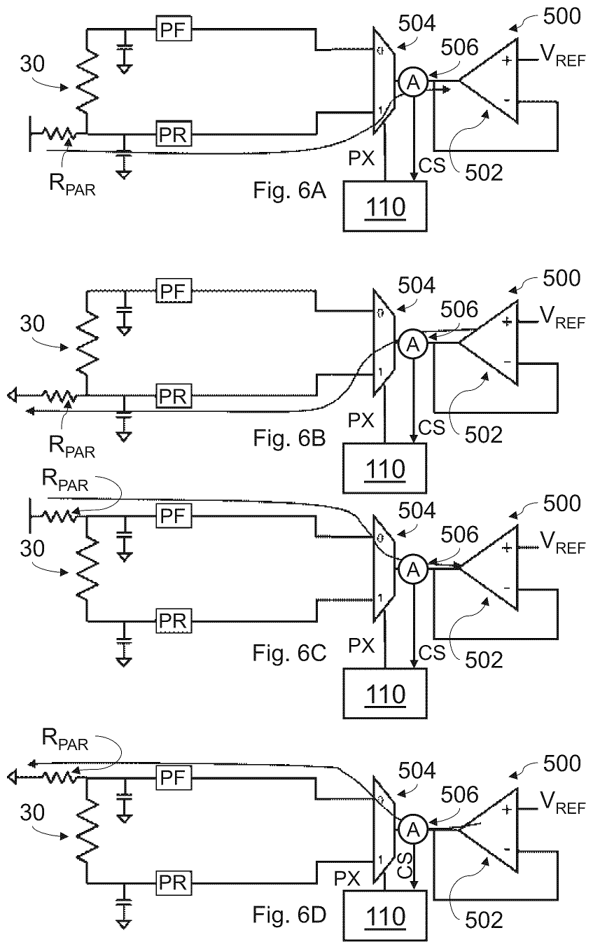

For example, in a first step, the control circuit 110 couples the voltage source 502 via the signal PX to the terminal PR. Accordingly, when the terminal PR is coupled via a parasitic (leakage) resistance RPAR to the supply voltage VSUP (see FIG. 6A), a current will flow from the terminal PR to the output of the voltage source 502. Upon determining that the signal CS indicates negative current flow, the control circuit 110 may detect a leakage error to the supply voltage VSUP.

Conversely, when the terminal PR is coupled via a parasitic (leakage) resistance RPAR to ground (see FIG. 6B), a current will flow from the output of the voltage source 502. to the terminal PR. Upon determining that the signal CS indicates a positive current flow, the control circuit 110 may detect a leakage error to ground.

In various embodiments, instead of detecting the leakage type, the control circuit 110 may determine whether the signal CS indicates that the measured current is substantially zero. On the contrary, a non-null current value indicates a leak at the terminal PR.

Accordingly, in response to detecting a leakage, the control unit 110 signals an error by asserting the fault signal FAULT, and by outputting at the data output terminal SDO a corresponding error code ZF.

Similarly, in a second step, the control circuit 110 couples the voltage source 502 via the signal PX to the terminal PF. Accordingly, when the terminal PF is coupled via a parasitic (leakage) resistance RPAR to the supply voltage VSUP (see FIG. 6C), a current will flow from the terminal PF to the output of the voltage source 502. Upon determining that the signal CS indicates negative current flow, the control circuit 110 may detect a leakage error to the supply voltage VSUP.

Conversely, when the terminal PF is coupled via a parasitic (leakage) resistance RPAR to ground (see FIG. 6D), a current will flow from the output of the voltage source 502. to the terminal PF. Upon determining that the signal CS indicates a positive current flow, the control circuit 110 may detect a leakage error to ground.

In various embodiments, instead of detecting the leakage type, the control circuit 110 may just determine whether the signal CS indicates that the measured current is substantially zero. On the contrary, a non-null current value indicates a leak at the terminal PF or PR, respectively.

Accordingly, upon detecting a leakage, the control unit 110 signals an error by asserting the fault signal FAULT and by outputting a corresponding error code ZF at the data output terminal SDO.

In a step 305, the control unit 110 obtains a value RM indicative of the resistance RPYRO between the terminals PF and PR. FIG. 7 also highlights the presence of parasitic wire resistances RW/2 and parasitic wire inductances LW/2, along with electrostatic discharge capacitances CESD and EMI suppression inductances LEMI.

Specifically, in various embodiments, the control circuit 110 enables the current limiters 510 and 512 during this test, e.g., by asserting the enable signals EN1 and EN2. Accordingly, a current IMEAS will flow through the pyrotechnic device 30. For example, in various embodiments, the current IMEAS is selected within a range of 5 to 100 mA, e.g., 20 to 60 mA, e.g., about 40 mA. In various embodiments, the value IMEAS may be settable, e.g., programmable. For example, programmable values disclosed herein may be received via the serial communication interface of the control circuit 110 or stored to a non-volatile

### Memory of the Control Circuit 110.

Next, in various embodiments, the control circuit 110 obtains a signal MV indicative of the voltage VPYRO between the terminals PF and PR, e.g., by using the ADC 170. In various embodiments, the control circuit 110 may also obtain a signal MI indicative of the current IPYRO provided via the terminals PF and PR. In this case, the control circuit 110 may compute the value MR (indicative of the resistance RPYRO) as the ratio MV/MI, i.e., MR=MV/MI.

In various embodiments, instead of explicitly measuring the current IPYRO, which should correspond to the maximum value IMEAS, the control circuit 110 may assume that the value MI corresponds to a predetermined value (corresponding to the value IMEAS), i.e., the control circuit 110 may compute the value MR (indicative of the resistance RPYRO) as the ratio MV/MI, i.e., MR=MV/MI, where MI is a predetermined value. In various embodiments, the control circuit 110 may assume that the value MI corresponds to a predetermined value (corresponding to the value IMEAS), and use the value MV for the value MR, i.e., MR=MV.

Specifically, if an undeployed pyrotechnic device 30 is coupled between the terminals PF and PR, the resistance RPYRO between them should be within an expected range. Accordingly, in various embodiments, the control circuit 110 compares the value MR (indicative of the resistance RPYRO) with a first and a second threshold, where the second threshold is greater than the first threshold. For example, a typical undeployed pyrotechnic device 30 should have a resistance value between 1 and 3Ω. Accordingly, in various embodiments, the first threshold may indicate a minimum resistance of a correctly coupled undeployed pyrotechnic device 30, e.g., a resistance of 1Ω, and the second threshold may indicate a maximum resistance of a correctly coupled undeployed pyrotechnic device 30, e.g., a resistance of 3Ω. In various embodiments, the first threshold or the second threshold may be settable, e.g., programmable.

Accordingly, in various embodiments, in response to determining that the value MR is smaller than the first threshold or greater than the second threshold, the control circuit 110 signals an error by asserting the fault signal FAULT, and by outputting at the data output terminal SDO a corresponding error code ZF for a connection error.

At step 306, the control unit 110 tests the switches 20a and 20b of the deployment driver 20. In particular, during step 306, the control unit 110 assesses whether the high-side switch 20a and the low-side switch 20b operate properly.

Such an assessment is performed by the voltage regulator and current monitor circuit 500 and comprises a first step, wherein the high-side switch 20a is tested, and a second step, wherein the low-side switch 20b is tested.

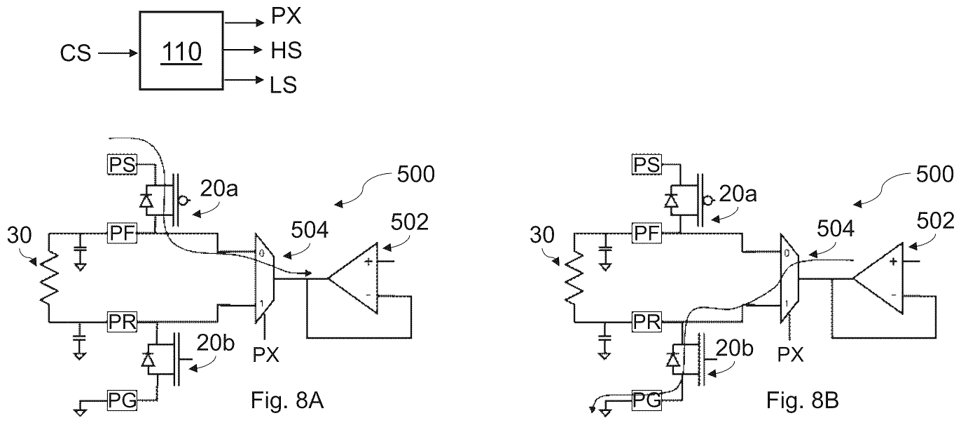

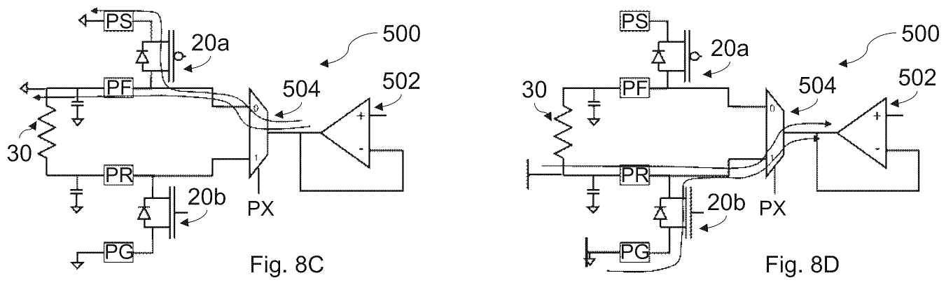

In particular, in a first step of the deployment, the switch diagnostics are performed, and the control circuit couples the voltage source 502 to the terminal PF. It closes the high-side switch 20a (while the low-side switch 20a is open), e.g., via a high-side control signal HS, thereby creating a short-to-battery condition, as shown in FIG. 8A.

Thus, in this condition, the signal CS should indicate a current flow towards the output of the voltage source 502. Consequently, the control unit 110 verifies whether the voltage regulator/current monitor module 500 detects a short-to-battery condition. On the positive side, the high-side switch 20a works correctly, whereas on the negative side, the high-side switch 20a is malfunctioning (e.g., as shown in FIG. 8C), and the control unit 110 signals the anomaly by asserting the fault signal FAULT, and by outputting at the data output terminal SDO a corresponding error code ZF.

Similarly, in a second step of the deployment switches diagnostics, the control circuit couples the voltage source 502 to the terminal PR. It closes the low-side switch 20b (while the high-side switch 20a is open), e.g., via a low-side control signal LS, thereby creating a short-to-ground condition, as shown in FIG. 8B.

Thus, in this condition, the signal CS should indicate a current flow from the output of the voltage source 502. Consequently, the control unit 110 verifies whether the voltage regulator/current monitor module 500 detects the short-to-ground. On the positive side, the low-side switch 20b works correctly; on the negative side, it is malfunctioning (e.g., as shown in FIG. 8D). The control unit 110 signals the anomaly by asserting the fault signal FAULT and by outputting a corresponding error code ZF at the data output terminal SDO.

Usually, it is not required to verify in this stage explicitly the open state of the high-side switch 20a, because this condition has already been verified implicitly via the previous tests, e.g., the tests of FIGS. 6A to 6B, which require that the high-side switch 20a and the low-side switch 20b are opened.

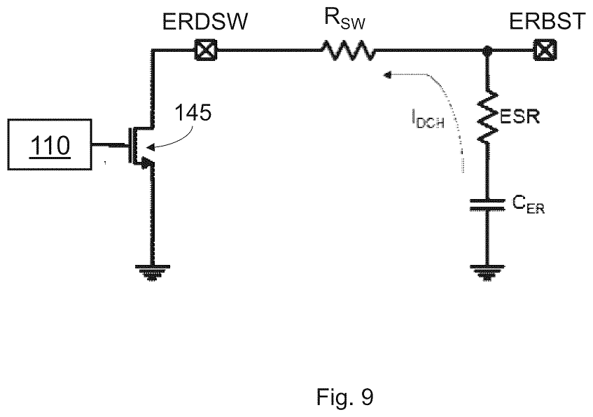

Successively, in a step 307, the control unit 110 performs a diagnostic of the energy reserve capacitor(s) CER. Such a diagnostic check is performed via the discharge circuit 145, as illustrated in FIG. 9.

In particular, during diagnostics of the energy reserve capacitor CER, the control unit 110 samples the supply voltage VSUP, e.g., by sampling the voltage at the terminal ERBST via the ADC 170. Next, the control circuit 110 enabled the discharge circuit 145 to discharge the capacitor CER. For example, as shown in FIG. 9, the discharge circuit 145 may be implemented with an electronic switch coupled between the terminal ERDSW and ground, e.g., the terminal BSTG. After a predetermined time delay, the control unit 110 disables the discharge circuit 145 and samples again the voltage across the discharge resistance RDCH through the ADC.

In various embodiments, at this point, the control unit 110 calculates the capacitance and Equivalent Series Resistance (ESR) values of the energy reserve capacitor CER and compares them with respective predetermined ranges.

If the obtained capacitance and ESR are within the specified ranges, the test indicates that the energy reserve capacitor CER is working properly, whereas if either the found capacitance or the ESR are outside the respective range, an anomaly of the energy recovery capacitor is signaled by asserting the fault signal FAULT, and by outputting at the data output terminal SDO a corresponding error code.

After executing step 307, the method 300 terminates. In various embodiments, the method 300 for performing diagnostics on the deployment system 100 may be repeated periodically. In various embodiments, the steps 301 to 307 may also be executed in a different order.

Accordingly, in various embodiments, the diagnostic circuit 110 may comprise the voltage regulator and current monitor circuit 500 and the current limiters 510 and 512. Conversely, during the various tests, the control circuit 110 generates various control signal to: couple the voltage regulator and current monitor circuit 500 to the terminal PF or PR, or decouple the voltage regulator and current monitor circuit 500; selectively enable the current limiter 510 or the current limiter 512; selectively close the high-side switch 20a or the low-side switch 20b; or selectively enabled the discharge circuit 145.

Moreover, during the various tests, the control circuit 110 monitors the signal CS (indicative of the current flowing through the output of the voltage source 502) or the signal DS at the output of the ADC 170, e.g., used to obtain the signal MV (indicative of the voltage between the terminals PF and PR).

Specifically, in various embodiments, the control circuit 110 is implemented as a hardware Finite-State Machine (FSM), e.g., a sequential logic circuit, configured to execute one or more of the test steps 301 to 307 in sequence while monitoring the signals CS and MR. For example, for this purpose, the FSM may comprise for each step 301 to 307 one or more respective states, e.g., to set control signals as described with respect to 4 to 9, wait a given time period, and proceed to the next state based on the value of the signal CS or DS.

As discussed before, one problem affecting the available solutions for testing squib or pyro-fuse deployment systems concerns the stress applied to electrical components, which may lead to premature ageing.

In this regard, the present solution includes countermeasures to prevent such early ageing.

In various embodiments, the method 300 for performing diagnostics on the deployment system 100 comprises additional checks for each step for controlling the execution rate ZT of each diagnostic control. For instance, the control unit 110 may comprise one or more values of repetition periods ZT associated to each testing step comprised in the diagnostic routine 300, indicating a time frequency at which each testing step is performed. Further, in various embodiments, the repetition periods ZT values may be stored in a memory included in the control unit 110, wherein the repetition periods ZT are programmable by accessing the control unit 110 through the communication interface. For example, the memory included in the control unit 110 may be a non-volatile memory, in such a way that once the repetition periods ZT are stored in the control unit 110 by accessing the memory through the communication interface, e.g., the Serial Peripheral Interface (SPI) bus, the values ZT are stored also in case of brown-outs or losses of power supply. Alternatively, the memory may be volatile, so that the deployment circuit 105, in particular the control unit 110, may acquire the desired repetition times ZT for each diagnostic step from the microcontroller 11.

Moreover, the control unit 110 may perform the controls discussed in the foregoing in a different order, or perform only a part of such tests. In particular, a reduced diagnostic routine comprising one or more steps of method 300 may be performed in response to specific events occurring in the vehicle.

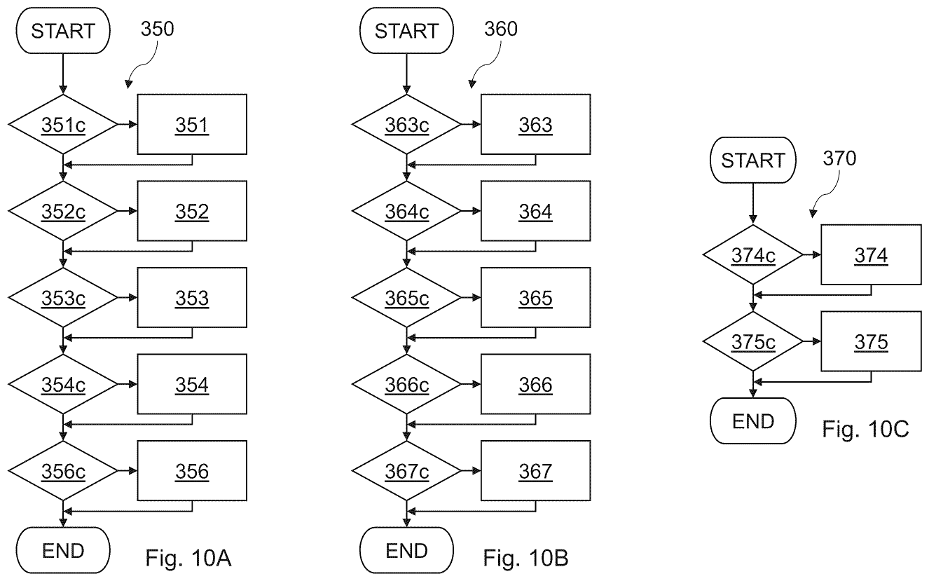

In this regard, FIGS. 10A, 10B, and 10C illustrate possible methods for implementing reduced diagnostic routines. As shown, each step of methods 350, 360, and 370 is coupled with a checking step, denoted by the suffix ‘c’ at the end of the label, that verifies whether the corresponding control is required.

In particular, FIG. 10A illustrates method 350 for performing diagnostics on the deployment system 100 according to the present solution during a power-up sequence.

For instance, such a method 350 may be executed at power-up of the deployment system 100, which may occur when a vehicle is started or undergoes a first start after manufacturing.

After a starting step, performed, for instance, at power-on of the vehicle, the control unit 110 may, in a first phase 351, test analog comparators, e.g., by executing an Analog Built-In Self-Test (ABIST), in accordance with the step 301 described above.

Successively, in a phase 352, the control unit 110 performs diagnostics of the analog-to-digital converters, e.g., a hardware self-check routine, in accordance with the step 302 of the method 300.

Consequently, the control unit 110 performs, in a phase 353, diagnostics of the voltage regulator and current monitor module 500 in accordance with the phase 303.

After diagnostics of the voltage regulator and current monitor module 500, the control unit 110 performs, in phase 354, the leakage test in accordance with phase 304 of the method 300.

Finally, in step 356, the control unit 110 tests the switches 20a, 20b in accordance with the phase 306 described above.

As anticipated above, in various embodiments, each step is associated with a respective repetition rate ZT. For instance, a first repetition rate ZT1 may be associated to the step 301 (or 351), in such a way that the control unit 110 executes such step only when requested. The repetition rates ZT and the check may be implemented, respectively, as an integer value and as a modulo operation on an iteration counter or index, which is incremented once for every time the method 300 (or 350) is repeated, and the integer value repetition rate ZT. If the modulo operation returns a value equal to zero, the corresponding diagnostic check is executed, while, on the contrary, the diagnostic check is skipped.

As a further example, FIG. 10B shows a flowchart representing a full run-time diagnostic sequence, embodied in a method 360.

In such full run-time diagnostic sequence, after a starting step, the control unit 110 performs the following diagnostic checks: testing the voltage regulator modules 130, 140, as performed in the phase 303, in a phase 363; performing a leakage test, as performed in the phase 204, in a phase 364; performing a resistance measurement test on the squib or pyro-fuse 30, as performed in the phase 305, in a phase 365; testing the switches 20a, 20b, as performed in the phase 306, in a phase 366; and performing an energy reserve capacitor diagnostic, as performed in the phase 307, in a phase 367.

As illustrated, also in this example each step is performed in response to verifying, in steps 363c, 364c, 365c, 366c, and 367c, that each respective repetition rate ZT is allowing the execution of a given step, at a given iteration of the method 360.

FIG. 10C illustrates a further example of a method 370, embodying an exemplary simplified run-time diagnostic routine.

Such method 370 comprises: performing a leakage test, as performed in the phase 304, in a phase 374; and performing a resistance measurement test on the squib or pyro-fuse 30, as performed in the phase 305, in a phase 375.

Such a method 370 may be executed iteratively, even when a vehicle is parked, while advantageously achieving lower power consumption than a system employing a microcontroller. This also reduces the stress applied to the electrical components.

In view of the above, the features of the present solution are clear, as well as its advantages. The solution described here advantageously facilitates the implementation of smart, low-power, fully autonomous sensors that, once configured, cyclically execute diagnostic routines on squib or pyro-fuse deployment systems.

As the present solution can operate with minimal intervention from any microcontroller unit or other external intelligence, it advantageously allows designers to save energy while maintaining satisfactory diagnostic reliability. In fact, a microcontroller coupled to the deployment circuit described herein may remain in a sleep state, waiting for signals from the deployment circuit in response to a fault, thus minimizing SPI traffic through the MCU's periodic wake-ups.

In other words, the solution described herein advantageously shifts the computational intelligence from the microcontroller to the deployment circuit 105. Further, independently specifying the execution rate for each step of the diagnostics routine increases the flexibility of such a solution and enables performing less stressful tests at higher rates while selecting lower scan rates for high-energy and high-power-consumption diagnostics.

Moreover, the deployment circuit 105 can automatically signal any detected fault to the microcontroller 11 while inhibiting further diagnostic steps to prevent misbehavior, thereby enabling interrupt-based diagnostic strategies that conserve MCU resources.

Of course, without prejudice to the principle of the disclosure, the details of construction and the embodiments may vary widely with respect to what has been described and illustrated herein purely by way of example, without thereby departing from the scope of the present disclosure, as defined by the ensuing claims.

This disclosure provides many applicable inventive concepts that can be embodied in a wide variety of specific contexts. The particular embodiments are merely illustrative of specific configurations and do not limit the scope of the claimed embodiments. Features from different embodiments may be combined to form further embodiments unless noted otherwise. Various embodiments are illustrated in the accompanying drawing figures, where identical components and elements are identified by the same reference number, and repetitive descriptions are omitted for brevity.

Variations or modifications described in one of the embodiments may also apply to others. Further, various changes, substitutions, and alterations can be made herein without departing from the spirit and scope of this disclosure as defined by the appended claims.

What is claimed is:

1. A deployment circuit for controlling a deployment of a pyrotechnic device, the deployment circuit comprising:
a positive supply terminal and a negative supply terminal configured to receive a supply voltage;
a first terminal and a second terminal couplable to the pyrotechnic device;
a driver circuit configured to energize the pyrotechnic device by coupling the first terminal and the second terminal to the supply voltage;
a diagnostic circuitry configured to perform diagnostics on the deployment circuit;
a communication interface couplable to a microcontroller;
a third terminal couplable to the microcontroller to provide a fault signal to the microcontroller;
a control circuit comprising a hardware Finite State Machine (FSM) configured to execute one or more diagnostic routines, each diagnostic routine comprising a sequence of diagnostic operations, each diagnostic operation comprising:
generating control signals for the diagnostic circuitry to execute a corresponding diagnostic operation,
monitoring one or more signals from the diagnostic circuitry,
asserting the fault signal in response to determining that the one or more signals indicate a fault of the deployment circuit,
storing a fault code indicative of the fault detected in response to determining that the one or more signals indicate the fault,
wherein the control circuit is configured to transmit the fault code in response to receiving, via the communication interface, a request.

2. The deployment circuit of claim 1, wherein the diagnostic circuitry comprises a voltage regulator and current monitor circuit, comprising:
a voltage source comprising an output terminal for providing a reference voltage;
a switching circuit configured to couple the output terminal of the voltage source to the first terminal and the second terminal as a function of a switching circuit control signal received from the control circuit; and
a current monitor configured to provide a signal indicative of a current flowing through the output terminal of the voltage source, wherein the signal is provided to the control circuit.

3. The deployment circuit of claim 2, wherein a first diagnostic operation comprises a first phase, wherein, in the first phase, the control circuit is configured to:
generate the switching circuit control signal to couple the output terminal of the voltage source to the first terminal,
monitor the signal indicative of the current flowing through the output terminal of the voltage source,
determine whether the signal indicates a current flow between the first terminal and the output terminal of the voltage source,
assert the fault signal and store a fault code indicative of a leakage condition at the first terminal in response to determining that the signal indicates a current flow between the first terminal and the output terminal of the voltage source.

4. The deployment circuit of claim 3, wherein the first diagnostic operation comprises a second phase, wherein, in the second phase, the control circuit is configured to:
generate the switching circuit control signal to couple the output terminal of the voltage source to the second terminal,
monitor the signal indicative of the current flowing through the output terminal of the voltage source,
determine whether the signal indicates a current flow between the second terminal and the output terminal of the voltage source,
assert the fault signal and store a fault code indicative of a leakage condition at the second terminal in response to determining that the signal indicates a current flow between the second terminal and the output terminal of the voltage source.

5. The deployment circuit of claim 4, wherein the driver circuit comprises:
a high-side electronic switch coupled between the positive supply terminal and the first terminal, wherein the high-side electronic switch is closed as a function of a high-side switch control signal received from the control circuit;
a low-side electronic switch coupled between the second terminal and the negative supply terminal, wherein the low-side electronic switch is closed as a function of a low-side switch control signal received from the control circuit;
wherein a second diagnostic operation comprises a first phase, wherein, in the first phase, the control circuit is configured to:
generate the switching circuit control signal to couple the output terminal of the voltage source to the first terminal,
generate the high-side switch control signal to close the high-side electronic switch,
monitor the signal indicative of the current flowing through the output terminal of the voltage source,
determine whether the signal indicates a current flow from the first terminal to the output terminal of the voltage source,
assert the fault signal and store a fault code indicative of failure of the high-side electronic switch in response to determining that the signal does not indicate a current flow from the first terminal to the output terminal of the voltage source.

6. The deployment circuit of claim 5, wherein the second diagnostic operation comprises a second phase, wherein the control circuit is configured to:
generate the switching circuit control signal to couple the output terminal of the voltage source to the second terminal,
generate the low-side switch control signal to close the low-side electronic switch,
monitor the signal indicative of the current flowing through the output terminal of the voltage source,
determine whether the signal indicates a current flow from the output terminal of the voltage source to the second terminal,
assert the fault signal and store a fault code indicative of failure of the low-side electronic switch in response to determining that the signal does not indicate a current flow from the output terminal of the voltage source to the second terminal.

7. The deployment circuit of claim 2, wherein the diagnostic circuitry comprises:
a first current limiter coupled between the positive supply terminal and the first terminal, wherein the first current limiter is enabled as a function of a first enable signal received from the control circuit; and
a second current limiter coupled between the second terminal and the negative supply terminal, wherein the second current limiter is enabled as a function of a second enable signal received from the control circuit.

8. The deployment circuit of claim 7, wherein a third diagnostic operation comprises a first phase, wherein, in the first phase, the control circuit is configured to:
generate the switching circuit control signal to couple the output terminal of the voltage source to the first terminal,
generate the first enable signal to enable the first current limiter,
monitor the signal indicative of the current flowing through the output terminal of the voltage source,
determine whether the signal indicates a current flow from the first terminal to the output terminal of the voltage source,
assert the fault signal and store a fault code indicative of failure of the voltage regulator and current monitor circuit and the first current limiter in response to determining that the signal does not indicate a current flow from the first terminal to the output terminal of the voltage source.

9. The deployment circuit of claim 8, wherein the third diagnostic operation comprises a second phase, wherein, in the second phase, the control circuit is configured to:
generate the switching circuit control signal to couple the output terminal of the voltage source to the second terminal,
generate the second enable signal to enable the second current limiter,
monitor the signal indicative of the current flowing through the output terminal of the voltage source,
determine whether the signal indicates a current flow from the output terminal of the voltage source to the second terminal,
assert the fault signal and store a fault code indicative of failure of the voltage regulator and current monitor circuit and the second current limiter in response to determining that the signal does not indicate a current flow from the output terminal of the voltage source to the second terminal.

10. The deployment circuit of claim 7, wherein the deployment circuit comprises:
an analog-to-digital converter comprising an input, wherein the analog-to-digital converter is configured to provide a signal indicative of a voltage at the input of the analog-to-digital converter; and
a second switching circuit configured to couple the input of the analog-to-digital converter to the first terminal and the second terminal as a function of a second switching circuit control signal received from the control circuit.

11. The deployment circuit of claim 10, wherein the diagnostic circuitry comprises:
a first voltage source configured to provide a first voltage;
a second voltage source configured to provide a second voltage;
wherein the second switching circuit is configured to couple the input of the analog-to-digital converter to the first voltage source or the second voltage source as a function of the second switching circuit control signal;
wherein a fourth diagnostic operation comprises a first phase, wherein, in the first phase, the control circuit is configured to:
generate the second switching circuit control signal to decouple the input of the analog-to-digital converter from the first terminal and the second terminal, and couple the input of the analog-to-digital converter to the first voltage source,
monitor the signal indicative of the voltage at the input of the analog-to-digital converter,
determine whether the signal has a first expected value,
assert the fault signal and store a fault code indicative of an analog-to-digital converter error in response to determining that the signal does not have the first expected value.

12. The deployment circuit of claim 11, wherein the fourth diagnostic operation comprises a second phase, wherein, in the second phase, the control circuit is configured to:
generate the second switching circuit control signal to decouple the input of the analog-to-digital converter from the first terminal and the second terminal, and couple the input of the analog-to-digital converter to the second voltage source,
monitor the signal indicative of the voltage at the input of the analog-to-digital converter,
determine whether the signal has a second expected value,
assert the fault signal and store a fault code indicative of an analog-to-digital converter error in response to determining that the signal does not have the second expected value.

13. The deployment circuit of claim 10, wherein a fifth diagnostic operation comprises the control circuit being configured to:
generate the second switching circuit control signal to couple the input of the analog-to-digital converter to the first terminal and the second terminal;
generate the first enable signal to enable the first current limiter and generate the second enable signal to enable the second current limiter;
monitor the signal indicative of the voltage at the input of the analog-to-digital converter;
determine a value indicative of a resistance between the first terminal and the second terminal as a function of the signal indicative of the voltage at the input of the analog-to-digital converter;
determine whether the value indicative of the resistance between the first terminal and the second terminal is between a first threshold and a second threshold; and
assert the fault signal and store a fault code indicative of an error of the pyrotechnic device in response to determining that the value indicative of the resistance between the first terminal and the second terminal is not between the first threshold and the second threshold.

14. The deployment circuit of claim 1, wherein the control circuit comprises a memory for storing:
first data indicating a repetition period for execution of at least one of the diagnostic routines, or
for each diagnostic operation, second data indicating after how many cycles of a given diagnostic routine the respective diagnostic operation should be executed;
wherein the control circuit is configured to execute the one or more diagnostic routines and the respective diagnostic operation as a function of the first data and the second data.

15. The deployment circuit of claim 14, wherein the first data or the second data is programmable via the communication interface.

16. The deployment circuit of claim 1, wherein the hardware Finite State Machine comprises a sequential logic circuit.

17. A method of operating a deployment circuit for controlling a deployment of a pyrotechnic device, the method comprising:
receiving, at a positive supply terminal and a negative supply terminal of the deployment circuit, a supply voltage;
coupling a first terminal and a second terminal of the deployment circuit to the pyrotechnic device;
energizing the pyrotechnic device by coupling the first terminal and the second terminal to the supply voltage via a driver circuit;
executing, via a control circuit comprising a hardware Finite State Machine (FSM), one or more diagnostic routines, each diagnostic routine comprising a sequence of diagnostic operations, each diagnostic operation comprising:
generating control signals for diagnostic circuitry to execute a corresponding diagnostic operation of the deployment circuit,
monitoring one or more signals from the diagnostic circuitry,
asserting a fault signal in response to determining that the one or more signals indicate a fault of the deployment circuit,
storing a fault code indicative of the fault detected in response to determining that the one or more signals indicate the fault;
receiving, via a communication interface of the deployment circuit, a request from a microcontroller; and
transmitting the fault code to the microcontroller in response to receiving the request.

18. The method of claim 17, further comprising:
coupling, via a switching circuit, an output terminal of a voltage source to the first terminal and the second terminal as a function of a switching circuit control signal generated by the control circuit;
providing, via a current monitor, a signal indicative of a current flowing through the output terminal of the voltage source to the control circuit;
wherein a first diagnostic operation comprises a first phase comprising:
generating the switching circuit control signal to couple the output terminal of the voltage source to the first terminal,
monitoring the signal indicative of the current flowing through the output terminal of the voltage source,
determining whether the signal indicates a current flow between the first terminal and the output terminal of the voltage source,
asserting the fault signal and storing a fault code indicative of a leakage condition at the first terminal in response to determining that the signal indicates a current flow between the first terminal and the output terminal of the voltage source.

19. A deployment system for controlling a deployment of a pyrotechnic device, the deployment system comprising:
a deployment circuit comprising:
a positive supply terminal and a negative supply terminal configured to receive a supply voltage,
a first terminal and a second terminal couplable to the pyrotechnic device,
a driver circuit configured to energize the pyrotechnic device by coupling the first terminal and the second terminal to the supply voltage,
diagnostic circuitry configured to perform diagnostics on the deployment circuit,
a communication interface couplable to a microcontroller,
a third terminal couplable to the microcontroller to provide a fault signal to the microcontroller,
a control circuit comprising a hardware Finite State Machine (FSM) configured to execute one or more diagnostic routines, each diagnostic routine comprising a sequence of diagnostic operations, each diagnostic operation comprising:
generating control signals for the diagnostic circuitry to execute a corresponding diagnostic operation,
monitoring one or more signals from the diagnostic circuitry,
asserting the fault signal in response to determining that the one or more signals indicate a fault of the deployment circuit,
storing a fault code indicative of the fault detected in response to determining that the one or more signals indicate the fault,
wherein the control circuit is configured to transmit the fault code in response to receiving, via the communication interface, a request; and
a microcontroller coupled to the deployment circuit, wherein the microcontroller is configured to:
receive the fault signal,
determine whether the fault signal is asserted,
send the request to the deployment circuit to receive the fault code in response to determining that the fault signal is asserted.

20. The deployment system of claim 19, wherein the microcontroller supports a normal operating state and a low-power state, wherein the microcontroller is configured to:
send a request to the deployment circuit to program:
first data indicating a repetition period for execution of at least one of the diagnostic routines, or
for each diagnostic operation, second data indicating after how many cycles of a given diagnostic routine the respective diagnostic operation should be executed;
enable the low-power state; and
enable the normal operating state and send the request to receive the fault code in response to determining that the fault signal is asserted.
